(19) United States
(12) Patent Application Publication
(10) Pub. No.: US 2003/0230028 A1
(43) Pub. Date: Dec. 18, 2003

(54) Decorative floral sleeve

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 10/413,738

(22) Filed: Apr. 15, 2003

Related U.S. Application Data
(63) Continuation-in-part of application No. 10/124,810, filed on Apr. 12, 2002.

(51) Int. Cl. A01G 9/02

(52) U.S. Cl. 47/72

(57) ABSTRACT

A floral sleeve sized to contain a flower pot, and method of use thereof, the sleeve generally having a hexagonal shape and which can be connected via a securing element to a pot disposed within the sleeve. The sleeve may have a detachable upper portion for supporting the sleeve from a support device or for enclosing a floral grouping disposed within the pot.

### CROSS REFERENCE TO RELATED APPLICATIONS

The present application is a continuation-in-part of U.S. Ser. No. 10/124,810, filed Apr. 12, 2002, the specification of which is hereby expressly incorporated herein by reference in its entirety.

### FIELD OF THE INVENTION

This invention generally relates to sleeves, and more particularly, decorative sleeves used to contain floral groupings with or without growing or retaining media, or used to wrap flower pots with or without floral groupings and/or media and methods of using same.

### BRIEF DESCRIPTION OF THE DRAWINGS

FIG. 1 is an elevational view of a sleeve constructed in accordance with the present invention.

FIG. 2 is a cross-sectional view of the sleeve of FIG. 1 taken along line 2-2.

FIG. 3 is a cross-sectional view of the sleeve of FIG. 1 taken along line 3-3.

FIG. 4 is a cross-sectional view of the sleeve of FIG. 1 taken along line 4-4.

FIG. 5 is an elevational view of a flower pot.

FIG. 6 is a cross-sectional view of the flower pot of FIG. 5 taken along line 6-6.

FIG. 7 is a perspective view of the sleeve of FIG. 1 secured about the flower pot of FIG. 5 via a securing element.

FIG. 8 is another perspective view of the sleeve of FIG. 1 secured about the flower pot of FIG. 5 with the securing element positioned above an upper end of the flower pot.

FIG. 9 is an elevational view of another sleeve constructed in accordance with the present invention.

FIG. 10 is a cross-sectional view of the sleeve of FIG. 9 taken along line 10-10.

FIG. 11 is an elevational view of another sleeve constructed in accordance with the present invention.

FIG. 12 is a cross-sectional view of the sleeve of FIG. 11 taken along line 12-12.

FIG. 13 is an elevational view of another sleeve constructed in accordance with the present invention.

FIG. 14 is a cross-sectional view of the sleeve of FIG. 13 taken along line 14-14.

FIG. 15 is an elevational view of another sleeve constructed in accordance with the present invention.

FIG. 16 is a cross-sectional view of the sleeve of FIG. 15 taken along line 16-16.

FIG. 17 is an elevational view of another sleeve constructed in accordance with the present invention.

FIG. 18 is a cross-sectional view of the sleeve of FIG. 17 taken along line 18-18.

FIG. 19 is an elevational view of the sleeve of FIG. 17 after the support extension has been detached.

FIG. 20 is a cross-sectional view of the sleeve of FIG. 19 taken along line 20-20.

FIG. 21 is an elevational view of another sleeve constructed in accordance with the present invention.

FIG. 22 is a cross-sectional view of the sleeve of FIG. 21 taken along line 22-22.

FIG. 23 is an elevational view of another sleeve constructed in accordance with the present invention.

FIG. 24 is a cross-sectional view of the sleeve of FIG. 23 taken along line 24-24.

FIG. 25 is a cross-sectional view of the sleeve of FIG. 23 taken along line 25-25.

FIG. 26 is a cross-sectional view of the sleeve of FIG. 23 taken along line 26-26.

FIG. 27 is an elevational view of another sleeve constructed in accordance with the present invention.

FIG. 28 is a cross-sectional view of the sleeve of FIG. 27 taken along line 28-28.

FIG. 29 is an elevational view of another sleeve constructed in accordance with the present invention.

FIG. 30 is a cross-sectional view of the sleeve of FIG. 29 taken along line 30-30.

FIG. 31 is an elevational view of another sleeve constructed in accordance with the present invention.

FIG. 32 is a cross-sectional view of the sleeve of FIG. 31 taken along line 32-32.

FIG. 33 is an elevational view of another sleeve constructed in accordance with the present invention.

FIG. 34 is a cross-sectional view of the sleeve of FIG. 33 taken along line 34-34.

FIG. 35 is an elevational view of another sleeve constructed in accordance with the present invention.

FIG. 36 is a cross-sectional view of the sleeve of FIG. 35 taken along line 36-36.

### DESCRIPTION OF THE PREFERRED EMBODIMENTS

The floral sleeves described and claimed herein have a number of advantages over preformed pot covers and sheets of material presently used in the floral industry to decorate and cover flower pots. In a preferred embodiment, the sleeves contemplated herein have polygonal shapes, such as hexagonal or heptagonal.

The floral sleeves contemplated herein generally are constructed of less material than many preformed pot covers, for example those covers known in the art as Speed Covers®. Constructed as they are in a flattened condition, they occupy less warehouse space. They are produced in a manner that allow them to be printed more economically and with a higher degree of quality and using a variety of printing techniques thereby achieving a wide variety of decorative effects. These sleeves reduce freight costs in comparison to covers having a three-dimensional or opened configuration. Sleeves such as claimed herein cost less to produce since their production is more highly automated. Less material is required to construct a flat floral sleeve than a Speed Covers® or other types of covers like injection-molded covers, sheets wrapped and banded about pots, or separate sleeves and covers used together. When used in conjunction with a “banding apparatus”, the sleeves contemplated herein lend themselves to being bandingly secured about pots more easily and efficiently than flat, non-tubular, sheets of material. Labor costs in the application of the presently claimed sleeves are reduced compared to most other types of covers since the pot covering portion and plant covering portion, where claimed herein, are applied simultaneously rather than in separate steps.

Also, the present sleeves automatically “center” themselves about the pot, unlike a flat sheet of material wherein the user must carefully position the pot on the flat sheet. This improves the efficiency of attaching the sleeve to the pot via an adhesive or cohesive material, or banding or other securing element, because correct placement of the cover is achieved more readily. Further, the application of labels to a sleeve is facilitated and more easily automated and is less costly than with many other types of covers. Further, production cost of making sleeves is reduced because tooling costs per unit are reduced, since it's easier to change from making one size of sleeves to another compared to changing the tooling for different sizes of Speed Covers®. Further the shape of the sleeve described herein, being somewhat oversized in relation to the pot intended to be placed in the sleeve, provides the sleeve with the billowy appearance, after being formed about the pot, of a flat sheet of material which has been formed about the pot, rather than the “flat” appearance of a sleeve placed about a pot. This billowy “sheet-like” appearance is greatly preferred by some purchasers over the traditional “sleeve-like” appearance of a sleeve. The present sleeve therefore provides an optimal solution to the problem of providing a floral sleeve which has the convenient features of a sleeve but which has the attractive billowy appearance of a flat sheet formed up about a pot.

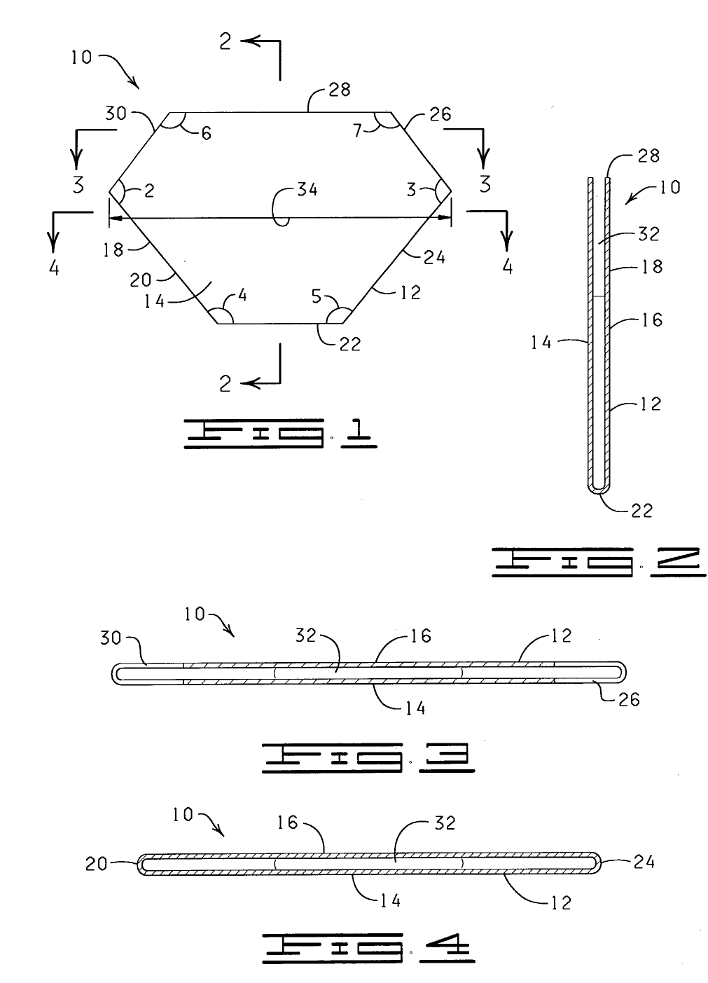

Turning now to the drawings, shown in FIGS. 1-4, and designated therein by the general reference numeral 10 is a flexible, preformed tubular floral sleeve (also referred to herein simply as a “sleeve”) having a hexagonal shape when in a flattened condition. The sleeve 10 can be opened from the flattened condition to an opened condition for receiving a pot, a flower pot, a floral grouping (alone or with a growing, ballast or retaining medium), or a pot with a botanical item disposed therein.

Sleeve 10 (FIGS. 1-4) comprises a body 12 having a hexagonal shape and having a front panel 14 and a back panel 16 which together comprise a sidewall 18 of the body 12. The body 12 comprises a hexagon having six sides, including a lower left side 20, a bottom side 22, a lower right side 24, an upper right side 26, a top side 28 and an upper left side 30. When the body 12 is opened from the flattened condition to an open condition, an interior space 32 sized to at least partially contain a pot 36 is exposed.

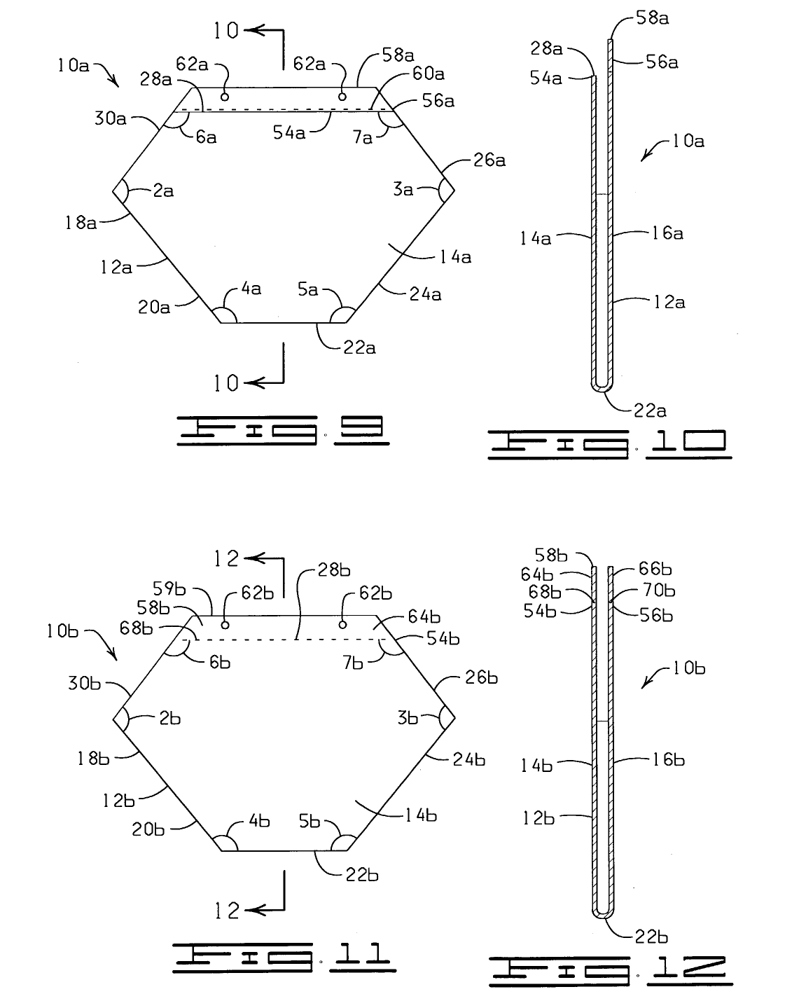

The body 12 has a maximum width 34 when in the flattened condition. The pot 36 (FIGS. 5 and 6) has an upper end 38 and a lower end 40. The pot 36 has a maximum diameter 42 which is usually near the upper end 38 and a minimum diameter 44 which is usually near the lower end 40.

The body 12 of sleeve 10 has six internal angles including angle 2 between upper left side 30 and lower left side 20, angle 3 between upper right side 26 and lower right side 24, angle 4 between lower left side 20 and bottom side 22, angle 5 between lower right side 24 and bottom side 22, angle 6 between upper left side 30 and top side 28, and angle 7 between upper right side 26 and top side 28. Each of angles 2, 3, 4, 5, 6 and 7 is less than 180°.

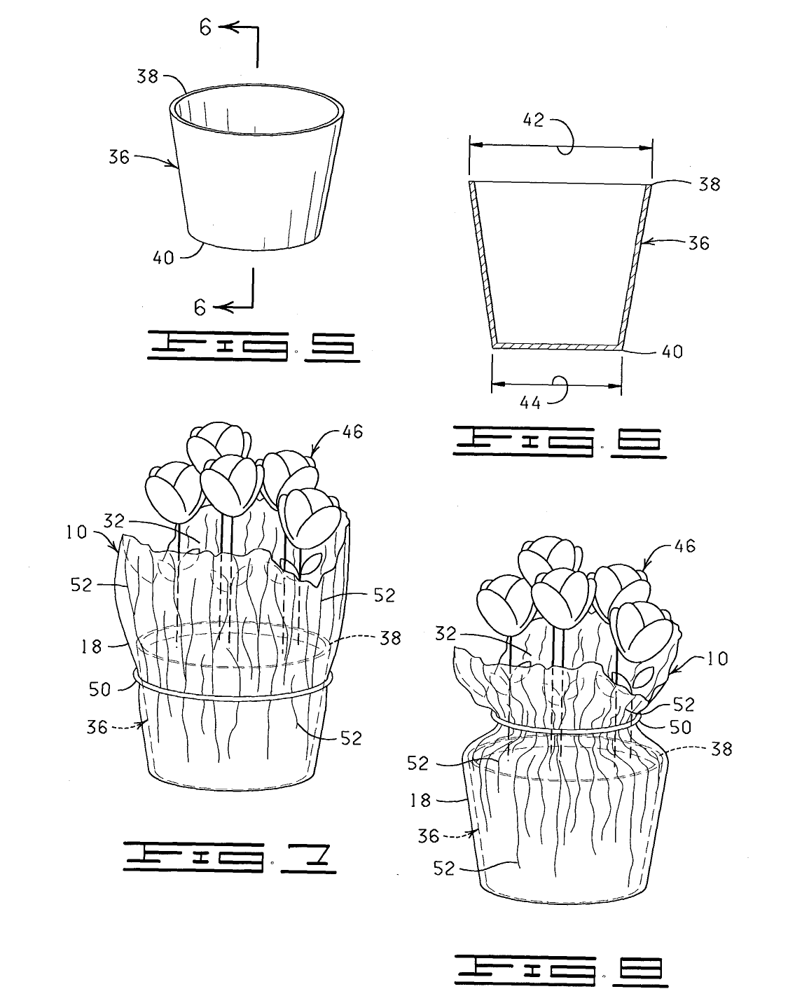

The maximum width 34 of the body 12 is generally the distance between angle 2 and angle 3. The lower left side 20, the bottom side 22 and the lower right side 24 are preferably closed (sealed for example with a lap seal, a heat seal, a butt seal, a fin seal, or any other appropriate seal or connection in any conventional manner known by a person of ordinary skill in the art) as shown in FIG. 2. Portions of the lower left side 20 and lower right side 24 which are near angles 2 and 3, respectively, may not be completely sealed to allow some expansion of those portions of the sleeve 10. The upper left side 30, the top side 28 and the upper right side 26 are preferably open, that is, unsealed, as shown in FIGS. 2 and 3, so they can be more effectively spread out when the pot 36 is disposed within the interior space 32 of the body 12 thereby providing the sleeve 10 with the appearance of a decorative flat sheet of material formed about the pot 36 as described above. The open upper left side 30 and open upper right side 26 enable portions of the body 12 to be flared out and adjusted upwardly, downwardly, inwardly, or outwardly to tailor the decorative effect provided by the sleeve 10.

In a preferred version of the invention, the pot 36 having a floral grouping 46 disposed therein is disposed within the sleeve 10 as shown in FIGS. 7 and 8. Shown in FIG. 7 is the sleeve 10 and the pot 36 which has been disposed within the interior space 32. In a preferred version of the method of use of the sleeve 10 contemplated herein (or any other sleeve described elsewhere herein), when the pot 36 is placed within the sleeve 10, a securing element 50 is manually or automatically placed about the sleeve 10 and the pot 36 for securing the sleeve 10 about the pot 36 and for forming a decorative effect provided when overlapping folds 52 are formed in the sidewall 18 of the sleeve 10 the securing element 50 may be positioned below the upper end 38 of the pot 36 (FIG. 7) or above the upper end 38 of the pot 36 (FIG. 8). The securing element 50 may be, for example, an elastic band, a rubber band, a plastic strip, a string, a tie, a wire, a ribbon, a heat shrinkable material, a paper collar, a polymer strip, a stribbon, a tape, a label, or other device typically used in the art as a securing device.

The sleeve 10 comprises “excess material” wherein the interior space 32 is substantially larger than necessary to contain the pot 36. When the sleeve 10 is applied about the pot 36 and secured thereabout forming the overlapping folds 52, the sleeve 10 provides the decorative appearance of a flat sheet of material which has been formed about the pot 36 and tied about the pot 36 with a tie. The overlapping folds 52 are restrained in an overlapping condition by the securing element 50.

In a preferred embodiment, the sleeve 10 has approximate dimensions of: about 3.75 inches for the upper left side 30 and upper right side 26, about 8.25 inches for the lower left side 20 and lower right side 24, about 5.25 inches for the bottom side 22, about 14.5 inches for the top side and about 17 inches for the maximum width 34. A sleeve 10 having these dimensions is sized to contain a pot 36 having an approximate maximum diameter 42 of six inches and an approximate minimum diameter 44 of four inches (a pot known in the floral industry as a “6-inch” pot).

Equivalent sizes of any of the sleeves described herein can be readily manufactured using methods known by persons of ordinary skill in the art for other standard sizes of pots such as 4 inch, 4.5 inch, 5 inch, 5.5 inch, 6 inch, 6.5 inch, 7 inch, 7.5 inch, 8 inch, and other sizes well known in the art and commercially available. In particular, as noted above, it is desirable to have excess material in the sidewall 18 of the sleeve 10 such that when the pot 36 is disposed in the sleeve 10 and the sleeve 10 is secured about the pot 36 via the securing element 50, overlapping folds 52 are formed in the sidewall 18. In order to provide sufficient excess material in the sidewall 18, the maximum width 34 of the body 12 is preferably a factor of at least 2.1 times greater than the maximum diameter 42 of the pot 36. Alternatively, the factor may be 2.16, 2.5, 2.8, 3.0 or 3.2, for example. Further, the maximum width 34 of the body 12 is preferably a factor of at least 3.2 times greater than the minimum diameter of the pot 36. Alternatively, the factor may be 3.5, 3.75, 4.0, 4.25, 4.5 or 4.75, for example.

In general, when a flat sleeve has a maximum width 34 which is a factor of about 1.66 greater than the maximum diameter of a pot, and which is a factor of about 2.5 greater than the minimum diameter of a pot, such a sleeve will fit closely about that pot. Therefore, in general, the maximum width 34 of the body 12 described herein will have a factor greater than 1.66 when compared to the maximum diameter 42 of the pot 36 and will have a factor greater than 2.5 when compared to the minimum diameter 44 of the pot 36.

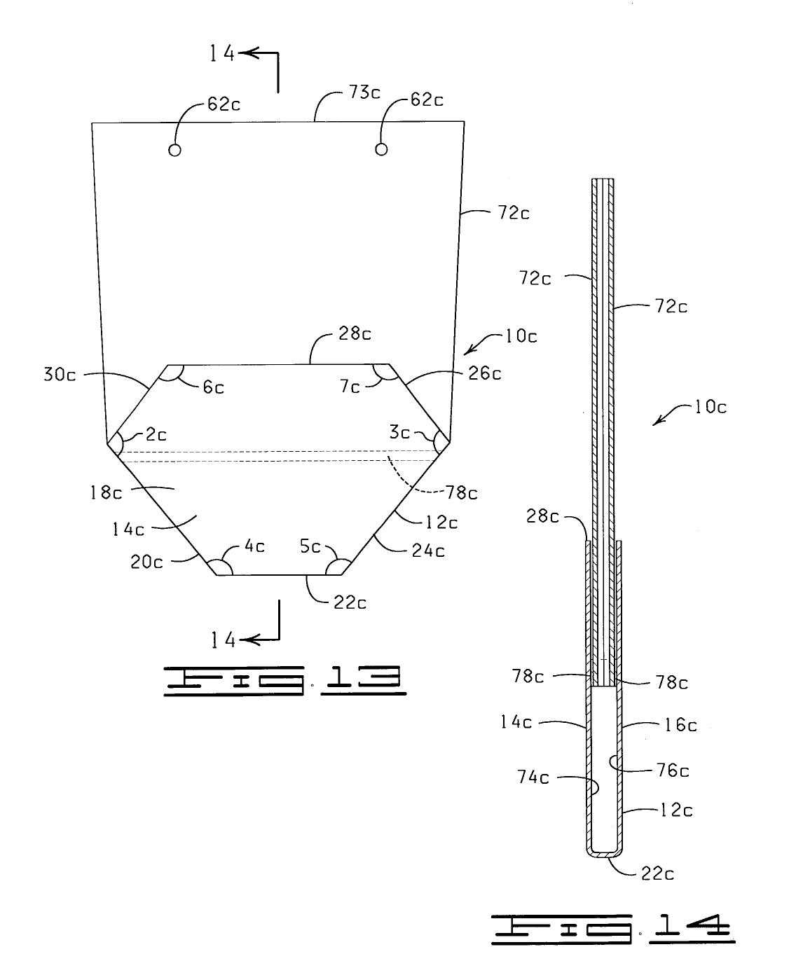

Shown in FIGS. 9 and 10 and referred to therein as floral sleeve 10a is a sleeve which is similar in all ways to sleeve 10 as described above, except as explained below. Sleeve 10a has a body 12a, a front panel 14a, a back panel 16a, a sidewall 18a comprising the front panel 14a and back panel 16a, a lower left side 20a, a bottom side 22a, a lower right side 24a, an upper right side 26a, a top side 28a, and an upper left side 30a.

Sleeve 10a differs from sleeve 10 in that it further comprises a support extension 58a which extends from a top end 56a of back panel 16a. Front panel 14a has a top end 54a. The support extension 58a is detachable via a detaching element 60a which is shown in FIG. 9 as comprising apertures 62a and a line of perforations but which may be in alternate embodiments, or tear strip, a zipper, or score line or weakened area, or any other device used as a detaching or tearing device. The support extension 58a serves to support the sleeve 10a from a support device such as a wicket, pin, hanger, staple, clip, adhesive or cohesive material, or other devices or means well known in the art for connecting or hanging sleeves together in a pad.

Generally, the support extension 58a is removed before the sleeve 10a is disposed about the pot 36 but may be removed after the sleeve 10a is disposed about the pot 36. The top side 28a comprises the top end 54a of the front panel 14a and the top end 56a of the back panel 16a (which is exposed as an edge when the support extension 58a is detached via the detaching element 60a).

The body 12a of sleeve 10a has six internal angles including angle 2a between upper left side 30a and lower left side 20a, angle 3a between upper right side 26a and lower right side 24a, angle 4a between lower left side 20a and bottom side 22a, angle 5a between lower right side 24a and bottom side 22a, angle 6a between upper left side 30a and top side 28a, and angle 7a between upper right side 26a and top side 28a. Each of angles 2a, 3a, 4a, 5a, 6a and 7a is less than 180°.

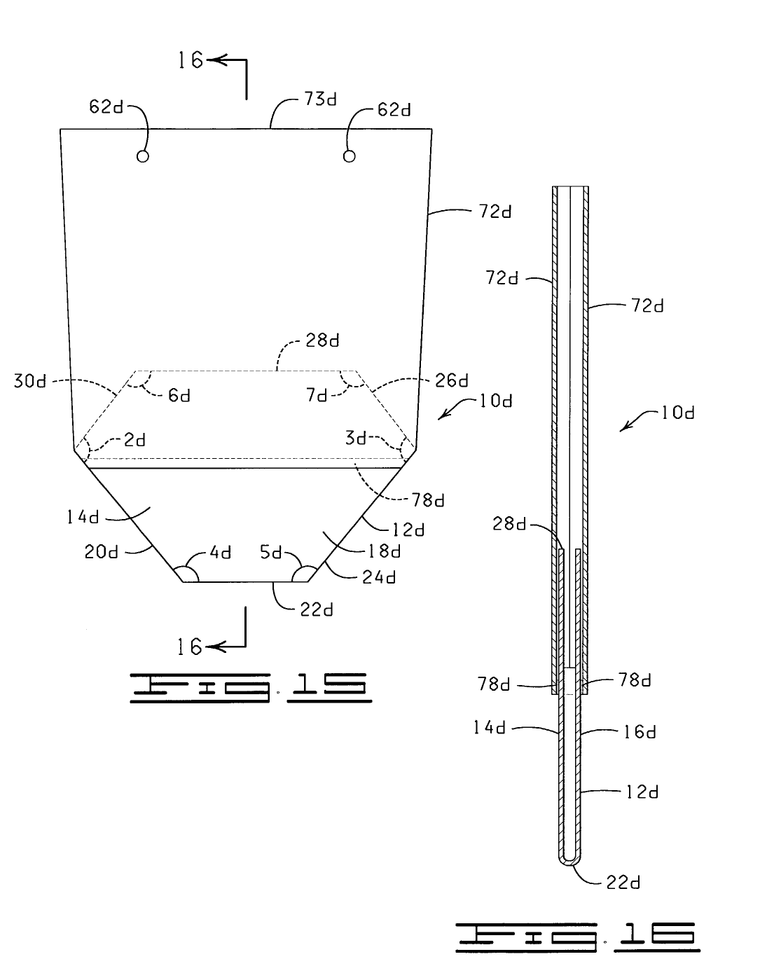

Shown in FIGS. 11 and 12 and referred to therein as floral sleeve 10b is a sleeve which is similar in all ways to sleeve 10 as described above except as explained below.

Sleeve 10b has a body 12b, a front panel 14b, a back panel 16b, a sidewall 18b, comprising the front panel 14b and back panel 16b, a lower left side 20b, a bottom side 22b, a lower right side 24b, an upper right side 26b, a top side 28b, and an upper left side 30b. Sleeve 10b differs from sleeve 10 in that it further comprises a support extension 58b which extends from the top side 28b which further comprises a front panel extension 64b which extends from a top end 54b of front panel 14b and a back panel extension 66b which extends from a top end 56b of back panel 16b. Support extension 58b has a top end 59b which may be open (unsealed) or closed (sealed). The support extension 58b preferably comprises apertures 62b adapted for use with a support device as described herein.

The support extension 58b is detachable via a front panel detaching element 68b for detaching the front panel extension 64b and a back panel detaching element 70b for detaching the back panel extension 66b, wherein the detaching elements 68b and 70b are like those defined elsewhere hereinabove. The support extension 58b serves to support the sleeve 10b from a support device such as a wicket, pin, hanger, staple, clip, adhesive or cohesive material, or other devices or means well known in the art for connecting or hanging sleeves together in a pad. As described above, the support extension 58b may be detached before or after the pot 36 is placed within the sleeve 10b.

The body 12b of sleeve 10b has six internal angles including angle 2b between upper left side 30b and lower left side 20b, angle 3b between upper right side 26b and lower right side 24b, angle 4b between lower left side 20b and bottom side 22b, angle 5b between lower right side 24b and bottom side 22b, angle 6b between upper left side 30b and top side 28b, and angle 7b between upper right side 26b and top side 28b. Each of angles 2b, 3b, 4b, 5b, 6b and 7b is less than 180°.

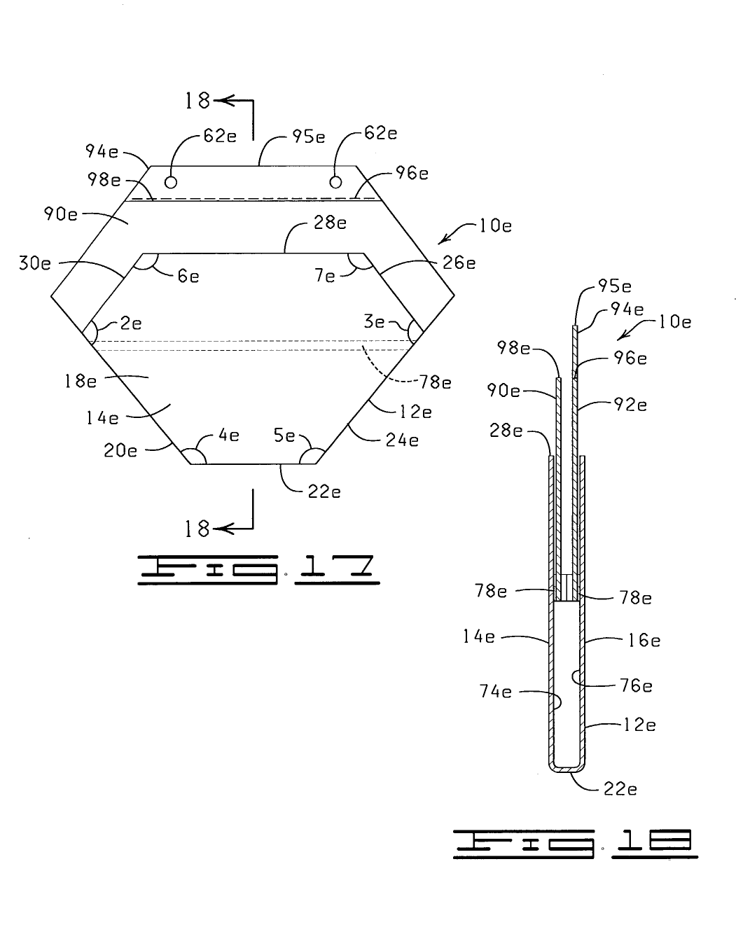

Shown in FIGS. 13 and 14 and referred to therein as floral sleeve 10c is a sleeve which is similar in all ways to sleeve 10 as described above, except as explained herein.

Sleeve 10c has a body 12c, a front panel 14c, a back panel 16c, a sidewall 18c, comprising the front panel 14c and back panel 16c, a lower left side 20c, a bottom side 22c, a lower right side 24c, an upper right side 26c, a top side 28c, and an upper left side 30c. Sleeve 10c differs from sleeve 10 in that it further comprises an upper portion 72c which extends beyond the topside 28c. The upper portion 72c is shown as optionally having apertures 62c for supporting the sleeve 10c from a support device such as a wicket.

Upper portion 72c has an upper end 73c and is attached to a portion of an inner surface 74c of front panel 14c and to a portion of an inner surface 76c of back panel 16c at an attached area 78c. The upper portion 72c has a tubular shape for enclosing and surrounding all of, or a portion of, the floral grouping 46 when the pot 36 and floral grouping 46 or floral grouping 46 alone is disposed within the sleeve 10c. The upper portion 72c can be detached from the body 12c after the pot 36 and/or floral grouping 46 have been disposed within the body 12c. The upper portion 72c may be detached via a detaching element (not shown) in the sleeve 10c. The upper portion 72c may also comprise apertures (not shown) for supporting the sleeve 10c from a support device as described elsewhere herein. The sleeve 10c may be gathered and/or connected into a pad as described elsewhere herein.

The body 12c of sleeve 10c has six internal angles including angle 2c between upper left side 30c and lower left side 20c, angle 3c between upper right side 26c and lower right side 24c, angle 4c between lower left side 20c and bottom side 22c, angle 5c between lower right side 24c and bottom side 22c, angle 6c between upper left side 30c and top side. 28c, and angle 7c between upper right side 26c and top side 28c. Each of angles 2c, 3c, 4c, 5c, 6c and 7c is less than 180°.

Shown in FIGS. 15 and 16 and referred to therein as floral sleeve 10d is a sleeve which is similar to sleeve 10c as described above, except as explained herein.

Sleeve 10d has a body 12d, a front panel 14d, a back panel 16d, a sidewall 18d comprising the front panel 14d and back panel 16d, a lower left side 20d, a bottom side 22d, a lower right side 24d, an upper right side 26d, a top side 28d, and an upper left side 30d. Sleeve 10d differs from sleeve 10c in that sleeve 10d comprises an upper portion 72d which is like upper portion 72c of sleeve 10c except upper portion 72d is attached to an outer surface 80d of front panel 14d and to an outer surface 82d of back panel 16d at an attached area 78d. Otherwise, sleeve 10d functions in a manner similar to sleeve 10c. The upper portion 72d is shown as optionally having apertures 62d for supporting the sleeve 10d from a support device such as a wicket.

The body 12d of sleeve 10d has six internal angles including angle 2d between upper left side 30d and lower left side 20d, angle 3d between upper right side 26d and lower right side 24d, angle 4d between lower left side 20d and bottom side 22d, angle 5d between lower right side 24d and bottom side 22d, angle 6d between upper left side 30d and top side 28d, and angle 7d between upper right side 26d and top side 28d. Each of angles 2d, 3d, 4d, 5d, 6d and 7d is less than 180°.

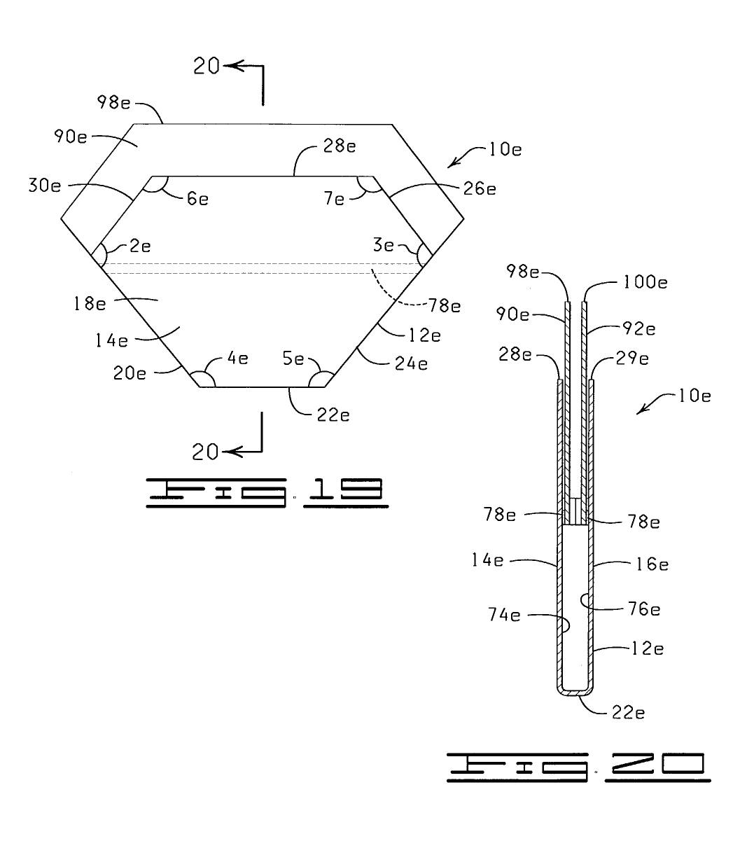

Shown in FIGS. 17 and 18 and referred to therein as floral sleeve 10e is a sleeve which is similar in all ways to sleeve 10 as described above, except as explained herein.

Sleeve 10e has a body 12e, a front panel 14e, a back panel 16e, a sidewall 18e, comprising the front panel 14e and back panel 16e, a lower left side 20e, a bottom side 22e, a lower right side 24e, an upper right side 26e, a top side 28e, and an upper left side 30e.

The body 12e of sleeve 10e has six internal angles including angle 2e between upper left side 30e and lower left side 20e, angle 3e between upper right side 26e and lower right side 24e, angle 4e between lower left side 20e and bottom side 22e, angle 5e between lower right side 24e and bottom side 22e, angle 6e between upper left side 30e and top side 28e, and angle 7e between upper right side 26e and top side 28e. Each of angles 2e, 3e, 4e, 5e, 6e and 7e is less than 180°.

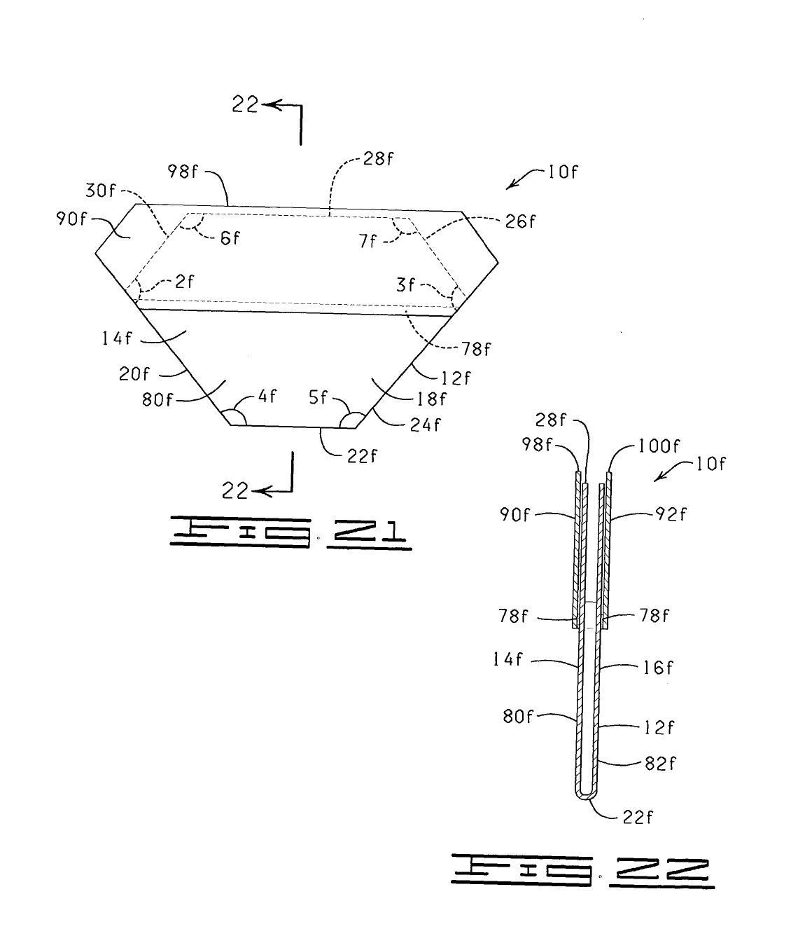

Sleeve 10e differs from sleeve 10 in that sleeve 10e further comprises a front decorative extension 90e which is attached at an attached area 78e to a portion of inner surface 74e of front panel 14e and a back decorative extension 92e which is attached to a portion of inner surface 76e of back panel 16e at attached area 78e. In one embodiment, as shown in FIG. 17, the sleeve 10e further comprises a support extension 94e having an upper end 95e which extends from the back decorative extension 92e (or alternatively, also from front decorative extension 90e) and which is detachable from back decorative extension 94e via a detaching element 96e as defined elsewhere herein. The support extension 94e may have apertures 62e therein for supporting the sleeve 10e from a support device such as a wicket or hook, or the support extension 94e may serve to attach a plurality of sleeves 10e together in a pad. The front decorative extension 90e has an upper peripheral edge 98e (FIGS. 17-19) and once the support extension 94e is detached, the back decorative extension 92e has an upper peripheral edge 100e (FIG. 20). Alternatively, the sleeve 10e may be constructed without the support extension 94e to initially have the configuration shown in FIG. 20. Preferably portions of the upper peripheral edges 98e and 100e of the front decorative extension 90e and the back decorative extension 92e, respectively, which extend from the body 12e near angles 2e and 3e, respectively, are unconnected or unsealed, although portions of upper peripheral edges 98e and 100e which are adjacent the angles 2e and 3e of the body 12e may be connected.

The upper peripheral edges 98e and 100e preferably generally correspond to the topside 28e, upper left side 30e and upper right side 26e of the body 12e. When a pot and/or floral grouping is disposed within the sleeve 10e, the sleeve 10e, due to the presence of the front decorative extension 90e and back decorative extension 92e, has the appearance of being formed from at least two separate sheets of material, thereby significantly enhancing the decorative effect of the sleeve 10e. The present invention also contemplates a sleeve such as sleeve 10e which has more than one front decorative extension 90e, more than one back decorative extension 92e, or more than one front decorative extension 90e and back decorative extension 92e for further enhancing the decorative effect of the sleeve.

In an alternative embodiment, the upper peripheral edges 98e and 100e may have shapes or patterns other than the straight edge pattern shown in FIGS. 17 and 19. For example, the upper peripheral edges 98e and 100e may be curved, wavy, irregular, toothed, notched, or have any other non-linear pattern. The upper left side 30e, top side 28e and upper right side 26e may similarly have non-linear shapes or patterns, while upper peripheral edges 98e and 100e are either straight or non-linear. Preferably at least a portion of upper peripheral edges 98e and 100e correspond to (i.e., match the shape or pattern of, e.g., are parallel to) all or portions of upper left side 30e, top side 28e, and upper right side 26e (and as are other sleeves described herein).

Shown in FIGS. 21 and 22 and referred to therein as floral sleeve 10f is a sleeve which is similar to sleeve 10e as described above, except as explained herein.

Sleeve 10f has a body 12f, a front panel 14f, a back panel 16f, a sidewall 18f comprising the front panel 14f and back panel 16f, a lower left side 20f, a bottom side 22f, a lower right side 24f, an upper right side 26f a top side 28f, and an upper left side 30f.

The body 12f of sleeve 10f has six internal angles including angle 2f between upper left side 30f and lower left side 20f, angle 3f between upper right side 26f and lower right side 24f, angle 4f between lower left side 20f and bottom side 22f, angle 5f between lower right side 24f and bottom side 22f, angle 6f between upper left side 30f and top side 28f, and angle 7f between upper right side 26f and top side 28f. Each of angles 2f, 3f, 4f, 5f, 6f and 7f is less than 180°.

Sleeve 10f differs from sleeve 10e in that sleeve 10f has a front decorative extension 90f which is like front decorative extension 90e, but instead is attached to an outer surface 80f of front panel 14f at an attached area 78f. Sleeve 10f further has a back decorative extension 92f which is like back decorative extension 92e but instead is attached to an outer surface 82f of back panel 16f at attached area 78f. Front decorative extension 90f has an upper peripheral edge 98f and back decorative extension 92f has an upper peripheral edge 10f. Upper peripheral edges 98f and 100f may be above, flush with, or below the left upper side 30f, top side 28f, and right upper side 26f, and may have shapes or patterns as described above for sleeve 10e. Further, sleeve 10f is shown without a detachable support extension like support extension 94e of sleeve 10e, but may alternately be equipped with such a support extension.

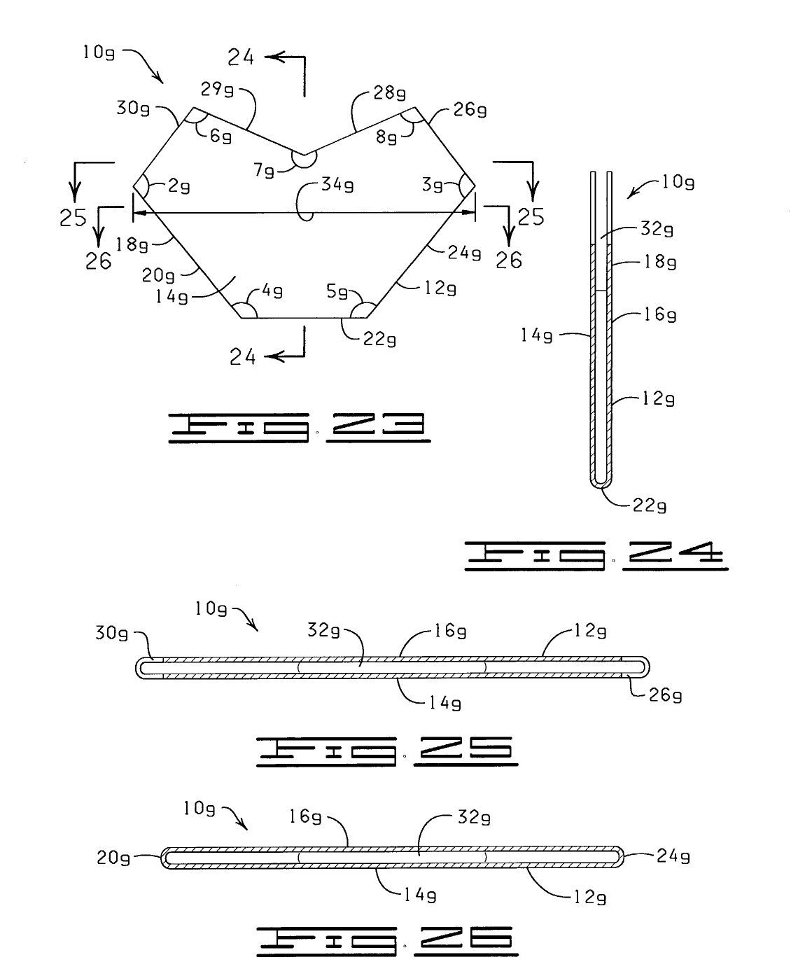

Shown in FIGS. 23-26, and designated therein by the general reference numeral log is a sleeve similar to sleeve 10 except having a heptagonal (seven-sided) shape when in a flattened condition. The sleeve 10g can be opened from the flattened condition to an opened condition for receiving a pot, a flower pot, a floral grouping (alone or with a growing, ballast or retaining medium), or a pot with a botanical item disposed therein.

Sleeve 10g comprises a body 12g having a heptagonal shape and having a front panel 14g and a back panel 16g which together comprise a sidewall 18g of the body 12g. The body 12g comprises a septagon having seven sides, including a lower left side 20g, a bottom side 22g, a lower right side 24g, an upper right side 26g, a right top side 28g, a left top side 29g, and an upper left side 30g. When the body 12g is opened from the flattened condition to an open condition, an interior space 32g sized to at least partially contain a pot 36 is exposed. The body 12g has a maximum width 34g when in the flattened condition.

The body 12g of sleeve log has seven internal angles including an angle 2g between upper left side 30g and lower left side 20g, an angle 3g between upper right side 26g and lower right side 24g, an angle 4g between lower left side 20g and bottom side 22g, an angle 5g between lower right side 24g and bottom side 22g, an angle 6g between upper left side 30g and left top side 29g, an angle 7g between left top side 29g and right top side 28g, and angle 8g between upper right side 26g and right top side 28g. Each of angles 2g, 3g, 4g, 5g, 6g, and 8g is less than 180°. Angle 7g is generally greater than 180°.

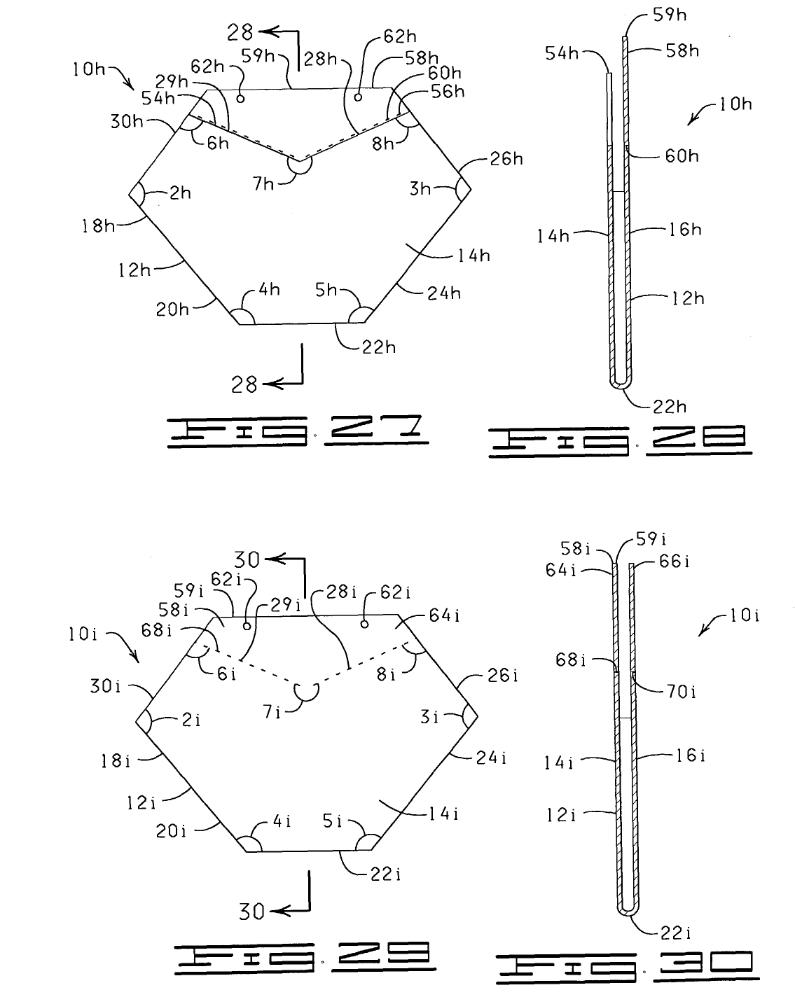

The maximum width 34g of the body 12g is generally the distance between angle 2g and angle 3g. The lower left side 20g, the bottom side 22g and the lower right side 24g are preferably closed (sealed for example with a lap seal, a heat seal, a butt seal, a fin seal, or any other appropriate seal or connection in any conventional manner known by a person of ordinary skill in the art) as shown in FIG. 24. The upper left side 30g, the left top side 29g, right top side 28g, and the upper right side 26g are preferably entirely open, that is, unsealed, (FIGS. 24 and 25), so they can be more effectively spread out when the pot 36 is disposed within the interior space 32g of the body 12g thereby providing the sleeve 10g with the appearance of a flat decorative sheet of material rather than a sleeve, which has been formed about the pot 36. The open upper left side 30g and open upper right side 26g enable portions of the body 12g to be flared out and adjusted upwardly, downwardly, inwardly, or outwardly to tailor the decorative effect provided by the sleeve 10g.

In a preferred embodiment, the sleeve log has approximate dimensions of: about 3.75 inches for the upper left side 30g and upper right side 26g, about 8.25 inches for the lower left side 20g and lower right side 24g, about 5.25 inches for the bottom side 22g, about 7.5 inches for the left top side 29g and the right top side 28g and about 17 inches for the maximum width 34g. A sleeve log having these dimensions is sized to contain a pot 36 having an approximate maximum diameter 42 of six inches and an approximate minimum diameter 44 of four inches (a pot known in the floral industry as a “6-inch” pot).

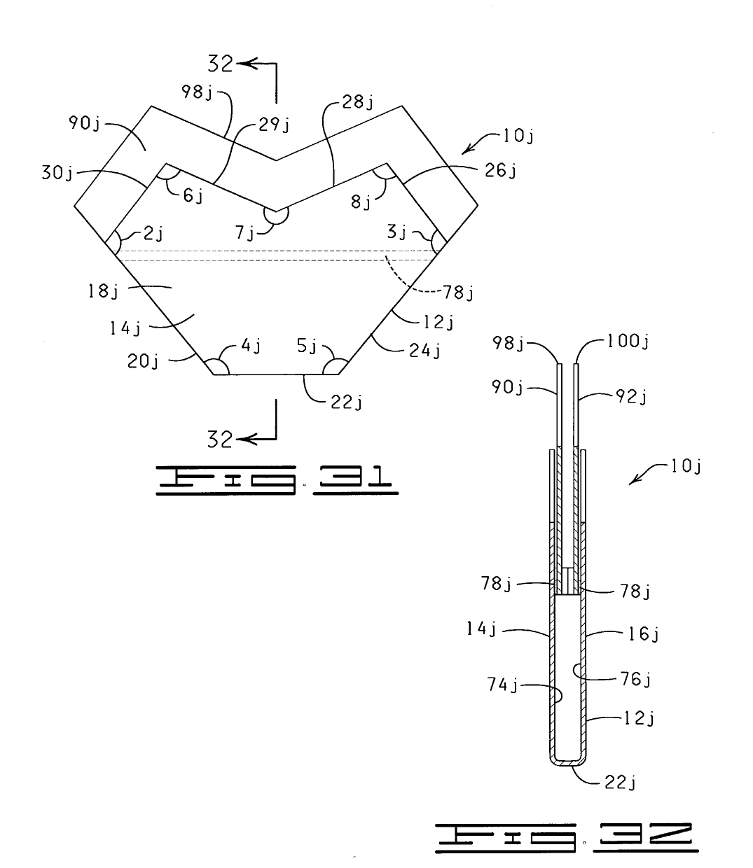

Shown in FIGS. 27 and 28 and referred to therein as floral sleeve 10h is a sleeve which is similar in all ways to sleeve 10g as described above, except as explained below. Sleeve 10h has a body 12h, a front panel 14h, a back panel 16h, a sidewall-18h comprising the front panel 14h and back panel 16h, a lower left side 20h, a bottom side 22h, a lower right side 24h, an upper right side 26h, a left top side 29h, a right top side 28h, and an upper left side 30h.

Sleeve 10h differs from sleeve 10h primarily in that it further comprises a support extension 58h which extends from a top end 56h of back panel 16h. Front panel 14h has a top end 54h. The support extension 58h may have apertures 62h and is detachable via a detaching element 60h which is shown in FIG. 27 as also comprising a line of perforations but which may be in alternate embodiments, or tear strip, a zipper, or score line or weakened area, or any other device used as a detaching or tearing device. The support extension 58h (like other support extensions described herein) serves to support the sleeve 10h from a support device such as a wicket, pin, hanger, staple, clip, adhesive or cohesive material, or other devices or means well known in the art for connecting or hanging sleeves together in a pad.

Generally, the support extension 58h is removed before the sleeve 10h is disposed about the pot 36 but may be removed after the sleeve 10h is disposed about the pot 36. The left top side 29h and right top side 28h together comprise the top end 54h of the front panel 14h and the top end 56h of the back panel 16h (which is exposed as a free edge when the support extension 58h is detached via the detaching element 60h).

The body 12h of sleeve 10h has seven internal angles including angle 2a between upper left side 30a and lower left side 20a, angle 3a between upper right side 26a and lower right side 24a, angle 4a between lower left side 20a and bottom side 22a, angle 5a between lower right side 24a and bottom side 22a, angle 6h between upper left side 30a and left top side 29h, an angle 7h between left top side 29h and right top side 28h, and angle 8h between upper right side 26a and right top side 28h. Each of angles 2h, 3h, 4h, 5h, 6h and 8h is less than 180°. Angle 7h is generally greater than 180°.

Shown in FIGS. 29 and 30 and referred to therein as floral sleeve 10i is a sleeve which is similar in all ways to sleeve log as described above except as explained below.

Sleeve 10i has a body 12i, a front panel 14i, a back panel 16i, a sidewall 18i, comprising the front panel 14i and back panel 16i, a lower left side 20i, a bottom side 22i, a lower right side 24i, an upper right side 26i, a left top side 29i, a right top side 28i, and an upper left side 30i. Sleeve 10i differs from sleeve 10g in that it further comprises a support extension 58i which extends from the right top side 28i and left top side 29i which further comprises a front panel extension 64i which extends from front panel 14i and a back panel extension 66i which extends from back panel 16i. Support extension 58i has a top end 59i which may be open (unsealed) or closed (sealed). The support extension 58i preferably comprises apertures 62b adapted for use with a support device as described herein.

The support extension 58i is detachable via a front panel detaching element 68i for detaching the front panel extension 64i and a back panel detaching element 70i for detaching the back panel extension 66i, wherein the detaching elements 68i and 70i are like those defined elsewhere hereinabove. The support extension 58i serves to support the sleeve 10i from a support device such as a wicket, pin, hanger, staple, clip, adhesive or cohesive material, or other devices or means well known in the art for connecting or hanging sleeves together in a pad. As described above, the support extension 58i may be detached before or after the pot 36 is placed within the sleeve 10i.

The body 12i of sleeve 10i has seven internal angles including angle 2i between upper left side 30i and lower left side 20i, angle 3i between upper right side 26i and lower right side 24i, angle 4i between lower left side 20i and bottom side 22i, angle 5i between lower right side 24i and bottom side 22i, angle 6i between upper left side 30i and left top side 29i, angle 7i between left top side 29i and right top side 28i, and angle 8i between upper right side 26i and top right side 28i. Each of angles 2i, 3i, 4i, 5i, 6i and 8i is less than 180°. Angle 7i is generally greater than 180°.

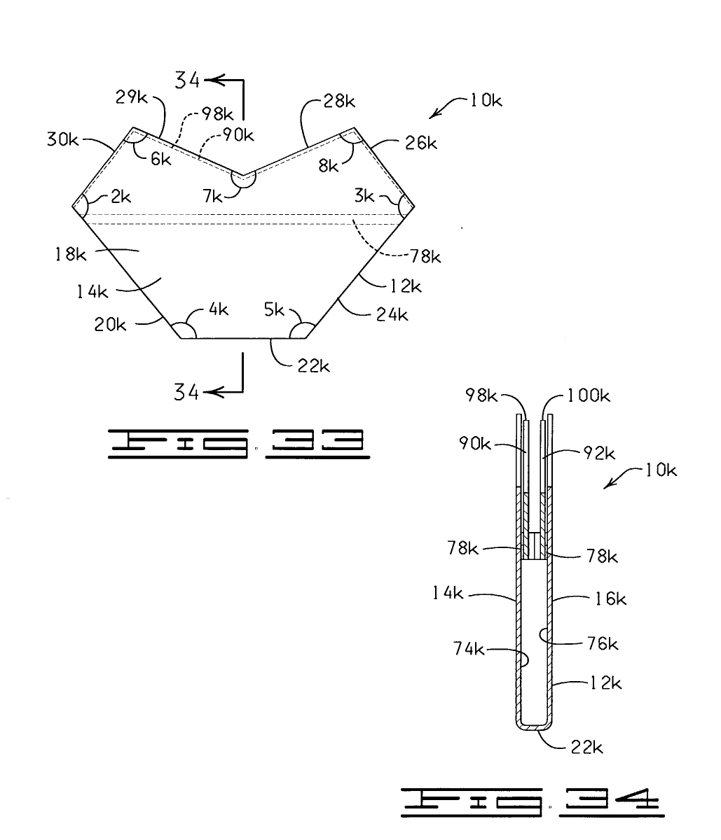

Shown in FIGS. 31 and 32 and referred to therein as floral sleeve 10i is a sleeve which is similar in all ways to sleeve log as described above, except as explained herein.

Sleeve 10j has a body 12j, a front panel 14j, a back panel 16j, a sidewall 18j, comprising the front panel 14j and back panel 16j, a lower left side 20j, a bottom side 22j, a lower right side 24j, an upper right side 26j, a left top side 29j, a right top side 28j, and an upper left side 30j. Sleeve 10j differs from sleeve 10g in that it further comprises a front decorative extension 90j and a back decorative extension 92j.

Front decorative extension 90j has an upper peripheral edge 98j and is attached to a portion of an inner surface 74j of front panel 14j at an attached area 78j. The back decorative extension 92j has an upper peripheral edge 100j and is attached to a portion of inner surface 76j of back panel 16j at attached area 78j. The sleeve 10j may be gathered with a plurality of sleeves 10j and connected as a pad as described elsewhere herein.

The body 12j of sleeve 10j has seven internal angles including an angle 2j between upper left side 30j and lower left side 20j, angle 3j between upper right side 26j and lower right side 24j, angle 4j between lower left side 20j and bottom side 22j, angle 5j between lower right side 24j and bottom side 22j, angle 6j between upper left side 30j and left top side 29j, an angle 7j between left top side 29j and right top side 28j, and angle 8j between upper right side 26j and right top side 28j. Each of angles 2j, 3j, 4j, 5j, 6j and 8j is less than 180°. Angle 7j is generally greater than 180°.

The upper peripheral edges 98j and 100j preferably generally correspond to the left top side 29j, right top side 28j, upper left side 30j, and upper right side 26j of the body 12j. When a pot and/or floral grouping is disposed within the sleeve 10j, the sleeve 10j, due to the presence of the front decorative extension 90j and back decorative extension 92j, has the appearance of being formed from at least two separate sheets of material, thereby significantly enhancing the decorative effect of the sleeve 10j. The present invention also contemplates a sleeve such as sleeve 10j which has more than one front decorative extension 90j, more than one back decorative extension 92j, or more than one front decorative extension 90j and back decorative extension 92j for further enhancing the decorative effect of the sleeve.

In an alternative embodiment, the upper peripheral edges 98j and 100j may have shapes or patterns other than the angular pattern shown in FIGS. 31 and 32. For example, the upper peripheral edges 98j and 100j may be curved, wavy, irregular, toothed, notched, or having other non-linear pattern. The upper left side 30j, left and right top sides 28j and 29j and upper right side 26j may similarly have non-linear shapes or patterns, while upper peripheral edges 98j and 100j are either straight, angular or non-linear.

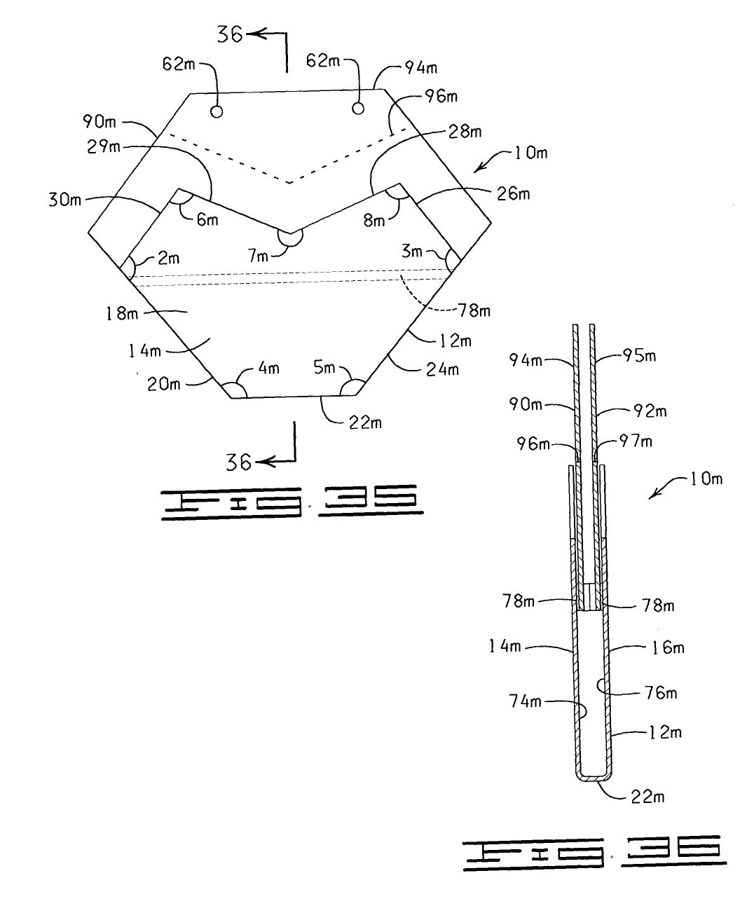

Shown in FIGS. 33 and 34 and referred to therein as floral sleeve 10k is a sleeve which is similar in all ways to sleeve 10j as described above, except as explained herein.

Sleeve 10k has a body 12k, a front panel 14k, a back panel 16k, a sidewall 18k, comprising the front panel 14k and back panel 16k, a lower left side 20k, a bottom side 22k, a lower right side 24k, an upper right side 26k, a left top side 29k, a right top side 28k, and an upper left side 30k. Sleeve 10k is similar to sleeve 10j in that it comprises a front decorative extension 90k and a back decorative extension 92k, each having an upper peripheral edge 98k and 100k respectively, and which are attached to a portion of an inner surface 74k of front panel 14k and to a portion of an inner surface 76k of back panel 16k at an attached area 78k, respectively. Sleeve 10k differs from sleeve 10j in that upper peripheral edges 98k and 100k are either flush with, or below, upper right side 26k, upper left side 30k, left top side 29k and right top side 28k. The sleeve 10k may further comprise a support extension which may be detached via a detaching element, as described elsewhere herein, and which may extend from any or all of the front panel 14k, the back panel 16k, the front decorative extension 90k, and/or the back decorative extension 92k. The sleeve 10k may be gathered and/or connected into a pad as described elsewhere herein.

The body 12k of sleeve 10k has seven internal angles including an angle 2k between upper left side 30k and lower left side 20k, angle 3k between upper right side 26k and lower right side 24k, angle 4k between lower left side 20k and bottom side 22k, angle 5k between lower right side 24k and bottom side 22k, angle 6k between upper left side 30k and left top side 29k, angle 7k between left top side 29k and right top side 28k, and angle 8k between upper right side 26k and right top side 28k. Each of angles 2k, 3k, 4k, 5k, 6k and 8k is less than 180°. Angle 7k is generally greater than 180°.

In al alternative embodiment, the upper peripheral edges 98j and 100j may have shapes or patterns other than the angular pattern shown in FIGS. 33 and 34. For example, the upper peripheral edges 98j and 100j may be curved, wavy, irregular, toothed, notched, or have any other non-linear pattern. The upper left side 30j left and right top sides 28j and 29j and upper right side 26j may similarly have non-linear shapes or patterns, while upper peripheral edges 98j and 100j are either straight, angular or non-linear.

Shown in FIGS. 35 and 36 and referred to therein as floral sleeve 10m is a sleeve which is similar in all ways to sleeve 10j as described above, except as explained herein.

Sleeve 10m has a body 12m, a front panel 14m, a back panel 16m, a sidewall 18m, comprising the front panel 14m and back panel 16m, a lower left side 20m, a bottom side 22m, a lower right side 24m, an upper right side 26m, a left top side 29m, a right top side 28m, and an upper left side 30m, a front decorative extension 90m attached at attached area 78m, and a back decorative extension 92m attached at attached area 78m. Sleeve 10m differs from sleeve 10j in that it further comprises a detachable front support extension 94m which extends from front decorative extension 90m and a detachable back support extension 95m which extends from back decorative extension 92m.

The front support extension 94m is detachable via a detaching element 96m and the back support extension 95m is detachable via a detaching element 97m. The front support extension 94m and back support extension 95m may have apertures 62m for supporting the sleeve 10m from a support device as described elsewhere herein, or the sleeve 10m may be gathered and/or connected into a pad as described elsewhere herein. The sleeve 10m may, in an alternative embodiment, have only one of front support extension 94m or back support extension 95m.

The body 12m of sleeve 10m has seven internal angles including angle 2m between upper left side 30m and lower left side 20m, angle 3m between upper right side 26m and lower right side 24m, angle 4m between lower left side 20m and bottom side 22m, angle 5m between lower right side 24m and bottom side 22m, angle 6m between upper left side 30m and left top side 29m, angle 7m between left top side 29m and right top side 28m, and angle 8m between upper right side 26m and right top side 28m. Each of angles 2m, 3m, 4m, 5m, 6m and 8m is less than 180°. Angle 7m is generally greater than 180°.

In an alternative embodiment, (not shown), the present invention comprises a sleeve such as sleeve 10k except wherein the sleeve has support extensions, such as front and back support extensions 94m and 95m of sleeve 10m, which extend from either the front and back panels 14k and/or 16k, respectively, and/or from the front and back decorative extensions 90k and/or 92k, respectively. Such support extensions would be detachable via detaching elements as described elsewhere herein.

Any of the sleeves described herein may have edges which are not straight, but which have curved, wavy, toothed, angular, irregular, or otherwise non-linear shapes or patterns. The pattern or shape may also comprise an identifiable form, design or decoration such as a cartoon figure, a rabbit, heart, flowers, stars or other figure or graphic representation. Of course, the bodies of any of the sleeves described herein may also have decorations, designs, printing, colorations, or other decorative features or representations, including works of art.

As discussed elsewhere herein, a plurality of sleeves 10-10m may be stacked together to form a pad and which may be supported on a support assembly such as a wicket, hanger or on a belt worn by a floral worker, for example in a greenhouse or plant warehouse or packaging or shipping facility such as shown in U.S. Ser. No. 10/124,810, which is expressly incorporated by reference herein in its entirety.

Any of the sleeves 10-10m shown herein or variations thereof contemplated or covered by the present description herein may be secured about the pot 36 in the manner shown in FIGS. 7 and 8.

The securing element 50 may be, for example, a rubber, elastic or cloth band, a string, a ribbon, a metal, paper or plastic collar, a wire, a band, a heat shrinkable strip, band or loop, an adhesive or cohesive, a label, a staple, or another banding device known to a person of ordinary skill in the art. The securing element 50 may be, in an alternative embodiment, preconnected to the sleeves 10-10m described herein before application of the sleeve about the pot 36 or it may be applied, either manually or automatically after the pot 36 has been disposed within the sleeves 10-10m.

The sleeves 10-10m are preferably constructed from material which is flexible, semi-rigid, rigid, or any combination thereof. The sleeves 10-10m may be constructed of a single layer of material or a plurality of layers of the same or different types of materials. Any thickness of the material may be utilized as long as the material functions in accordance with the present invention and is expandable to an open position as described herein. The layers of material comprising the sleeves 10-10m may be connected together or laminated or may be separate layers. Such materials used to construct the sleeves 10-10m are described in U.S. Pat. No. 5,111,637, for example, which is hereby incorporated herein by reference. Any thickness of material may be utilized in accordance with the present invention as long as the sleeves 10-10m may be formed as described herein, and as long as the sleeves 10-10m may contain at least a portion of the pot 36 or potted plant or floral grouping 46, as described herein. Additionally, an insulating material such as bubble film, preferable as one of two or more layers, can be utilized in order to provide additional protection for the item, such as the floral grouping 46, contained therein.

Generally the material from which the sleeves 10-10m are constructed has a thickness in a range from about 0.1 mil to about 30 mils. Often, the thickness of the material used to construct the sleeves 10-10m ranges from about 0.5 mil to about 10 mils. Preferably, the sleeves 10-10m have a thickness in a range from about 1.0 mil to about 5 mils.

In one embodiment, the sleeves 10-10m may be constructed from a sheet comprising two polypropylene films. The material comprising the sleeves 10-10m may be connected together or laminated or may be separate layers. In alternative embodiments, the sleeves 10-10m may be constructed from only one of the polypropylene films.

The sleeves 10-10m are constructed from any suitable material that is capable of being formed into sleeves 10-10m and wrapped about pot 36 and floral grouping 46 disposed therein. Preferably, the material comprises untreated or treated paper, metal foil, polymeric film, non-polymeric film, woven or nonwoven fabrics, synthetic or natural fabrics, cardboard, fiber, cloth, burlap, or laminations or combinations thereof.

The term “polymeric film” means a man-made polymer such as a polypropylene or a naturally occurring polymer such as cellophane. A polymeric film is relatively strong and not as subject to tearing (substantially non-tearable), as might be the case with paper or foil.

The material comprising the sleeves 10-10m may vary in color and may consist of designs or decorative patterns which are printed, etched, and/or embossed thereon using inks or other printing materials. An example of an ink which may be applied to the surface of the material is described in U.S. Pat. No. 5,147,706, and which is hereby expressly incorporated herein by reference in its entirety.

In addition, the material used to construct the sleeves 10-10m may have various colorings, coatings, flocking and/or metallic finishes, or other decorative surface ornamentation applied separately or simultaneously or may be characterized totally or partially by pearlescent, translucent, transparent, iridescent, neon, or the like, qualities. The material may further comprise, or have applied thereto, one or more scents. Each of the above-named characteristics may occur alone or in combination and may be applied to the upper and/or lower surface of the material comprising the sleeves 10-10m. Moreover, portions of the material used in constructing the sleeve may vary in the combination of such characteristics. The material utilized for the sleeves 10-10m may be opaque, translucent, transparent, or partially clear or tinted transparent. Any portion of the sleeves 10-10m, or the entire sleeves 10-10m may have a design, pattern or decoration printed thereon.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping comprises a bloom or foliage portion and a stem portion. Further, the floral grouping may comprise a growing potted plant having a root portion (not shown) as well. However, it will be appreciated that the floral grouping may consist of only a single bloom or only foliage, or a botanical item (not shown), or a propagule (not shown). The term “floral grouping” may be used interchangeably herein with both the terms “floral arrangement” and “potted plant”. The term “floral grouping” may also be used interchangeably herein with the terms “botanical item” and/or “propagule.”

The term “growing medium” when used herein means any liquid, solid or gaseous material used for plant growth or for the cultivation of propagules, including organic and inorganic materials such as soil, foam, humus, perlite, vermiculite, sand, beads, water, and including the nutrients, fertilizers or hormones or combinations thereof required by the plants or propagules for growth and also may merely be a “retaining” or “ballast” material which does not aid in growth but helps in supporting the sleeve 10-10m in an opened condition.

The term “botanical item” when used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as bouquet or floral grouping.

The term “propagule” when used herein means any structure capable of being propagated or acting as an agent of reproduction including seeds, shoots, stems, runners, tubers, plants, leaves, roots or spores.

An adhesive or cohesive bonding material may be disposed on a portion of the sleeves 10-10m to assist in holding the sleeves 10-10m to the pot 36 therein when such the pot 36 is disposed within the sleeves 10-10m. A second bonding material (not shown) may be applied to an upper portion of the upper portions 72c and 72d (or other upper portions shown herein) near the upper ends 73c and 73d, respectively, for sealing the upper portion 72c-72d of the sleeve 10c-10d, after the pot 36 has been disposed therein.

Where present, the bonding materials may be disposed as a strip or block on a surface of the sleeves 10-10m. Further, the bonding materials may be disposed as spots, or in any other geometric, non-geometric, asymmetric, or fanciful form, and in any pattern including covering either the entire inner surfaces of the sleeves 10-10m. The bonding materials may be covered by a cover or release strip which can be removed prior to the use of the sleeves 10-10m. The bonding materials can be applied by means known to those of ordinary skill in their art.

The term “bonding material” when used herein means an adhesive, frequently a pressure sensitive adhesive, or a cohesive. When the bonding material is a cohesive, a similar cohesive material must be placed on the adjacent surface (e.g. on the outer surface of the pot) for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonic sealable and vibratory sealable. The term “bonding material” when used herein also means a heat sealing lacquer or hot melt material which may be applied to the material and, in this instance, heat, sound waves, or vibrations, also must be applied to effect the sealing.

Any of the sleeves 10-10m described herein may also be equipped with one or more drainage holes in or near a bottom side 22-22m, respectively, thereof or ventilation holes (not shown) or can be made from permeable or impermeable materials.

Preferably the sleeves 10-10m are sized to contain and conform to one of a variety of standard sizes of pots 36 known to those of ordinary skill in the art, such as described above. As noted above, the sleeves 10-10m may be used to contain a plant and a growing medium without the use of the pot 36.

In an alternative embodiment, any of the floral sleeves described herein may be constructed of a dead fold material (i.e., a material such as a metal foil, or metalized polymer film which after forming is able to hold a non-flat shape) such that when a pot and/or floral grouping is disposed within the interior space of the body of the floral sleeve and overlapping folds are formed therein, a separate securing element is not necessary in order to restrain the overlapping folds in an overlapping condition.

In alternate embodiments of the invention, the polygonal shape of the floral sleeve may include (but is not limited to) pentagonal, octagonal, nonagonal or decagonal shapes.

The term “pot” as used herein refers to any type of container or vase used for holding a floral grouping or plant. Examples of pots, used in accordance with the present invention include, but not by way of limitation, clay pots, wooden pots, foam pots, plastic pots, pots made from natural and/or synthetic fibers, or any combination thereof. The pot is generally adapted to receive a floral grouping in the retaining space. The floral grouping may be disposed within the pot along with a suitable growing medium described in further detail below, or other retaining medium, such as a floral foam. It will also be understood that the floral grouping, and any appropriate growing medium or other retaining or ballast medium, may be disposed in the sleeves 10-10m without the pot 36 or other container.

The sleeves 10-10m described herein may be formed in a manner well known in the art by advancing two separate webs, one or two webs preformed in the form of a tube, or a single web folded double, or multiple parallel overlapping webs and sealing potions of the longitudinal sides and sealing the bottom side of the two facing panels then cutting the sleeve thus formed from the webs or web. Machines which can form sleeves from such single webs, or multiple pairs of webs are well within the knowledge of one of ordinary skill in the art.

It should be further noted that various other features of the versions of the present invention described herein such as closure bonding areas, support extensions, handles, additional perforations, drainage holes, ventilation holes, combinations of material may be used alone or in combination as elements of any of the embodiments described above herein.

The sleeves 10-10m may comprise a portion of a plant package as shown for example in FIGS. 7 and 8, which additionally comprises the pot 36 disposed within the sleeve 10-10m, the pot 36 may have the floral grouping 46 disposed therein wherein the pot assembly is substantially surrounded and encompassed by the sleeve 10-10m or a portion thereof. Alternatively, the plant package may comprise only the sleeve 10-10m, the floral grouping 46, and a retaining, ballast, or growing medium for supporting the floral grouping 46.

These embodiments described herein are not intended to limit the scope and extent of the claimed invention but are only intended to exemplify various embodiments of the invention contemplated herein.

Changes may be made in the construction and the operation of the various components, elements and assemblies described herein or in the steps or the sequence of steps of the methods described herein without departing from the spirit and scope of the invention as defined in the following claims.

What is claimed is:

1. A floral sleeve, comprising:
a body having a sidewall comprising a front panel and a back panel, the body initially having a flattened condition and the body, when in the flattened condition, having a polygonal shape comprising a lower left side, a bottom side, a lower right side, an upper right side, a top side, and an upper left side, and wherein the lower left side, the bottom side, and the lower right side are substantially closed and the upper right side, the top side, and the upper left side are open, the body having a tapered lower portion, and the body having an interior space when opened to an opened condition, the interior space sized to at least partially contain a pot and/or floral grouping, the floral sleeve further comprising at least one front decorative extension attached to an inner surface or an outer surface of the front panel and at least one back decorative extension attached to an inner surface or outer surface of the back panel, and wherein the front decorative extension and the back decorative extension provide the floral sleeve with an appearance of being formed from at least two separate sheets of decorative material when the floral sleeve is formed and secured about the pot and/or floral grouping.

2. The floral sleeve of claim 1 wherein the polygonal shape of the body is hexagonal.

3. The floral sleeve of claim 1 wherein the polygonal shape of the body is heptagonal.

4. The floral sleeve of claim 1 wherein the top side of the body comprises a left top side and a right top side.

5. The floral sleeve of claim 1 wherein the front decorative extension and back decorative extension extend beyond the top side of the body.

6. The floral sleeve of claim 1 wherein the front decorative extension and back decorative extension are substantially flush with the top side of the body.

7. The floral sleeve of claim 1 wherein the front decorative extension and the back decorative extension are positioned below the top side of the body.

8. The floral sleeve of claim 1 wherein a portion of an upper peripheral edge of the front decorative extension is parallel to the top side, upper left side and upper right side of the body.

9. The floral sleeve of claim 1 wherein a portion of an upper peripheral edge of the back decorative extension is parallel to the top side, upper left side and upper right side of the body.

10. The floral sleeve of claim 1 wherein the body of the floral sleeve comprises a tapered lower portion below a maximum diameter of the body and a tapered upper portion above the maximum diameter of the body.

11. The floral sleeve of claim 1 wherein the top side, upper left side, and upper right side of the body have a non-linear pattern.

12. The floral sleeve of claim 1 further comprising a support extension for supporting the floral sleeve from a support device or for connecting a plurality of the floral sleeves into a pad.

13. The floral sleeve of claim 12 wherein the support extension extends from at least one of the front decorative extension and the back decorative extension.

14. The floral sleeve of claim 12 wherein the support extension is detachable via a detaching element in the floral sleeve.

15. The floral sleeve of claim 1 wherein the floral sleeve further comprises an upper portion sized to enclose a floral grouping disposed within the pot after the pot and floral grouping have been disposed within the floral sleeve.

16. The floral sleeve of claim 1 wherein the floral sleeve is constructed of a material selected from the group consisting of treated or untreated paper, metal foil, polymeric film, non-polymeric film, metallized polymeric film, fiber, fabric, and laminations or combinations thereof.

17. The floral sleeve of claim 1 wherein the body of the floral sleeve comprises a dead fold material.

18. The floral sleeve of claim 17 wherein the dead fold material comprises a metal foil.

19. The floral sleeve of claim 1 further defined as constructed from a material having a thickness in a range of from about 0.1 mil to about 30 mils.

20. A plant package comprising a pot and/or floral grouping and the floral sleeve of claim 1.

21. The plant package of claim 20 wherein the floral sleeve is secured about the pot and/or floral grouping via a securing element.

22. The plant package of claim 21 wherein the securing element is selected from the group consisting of a rubber band, an elastic band, a heat shrinkable band or strip, a string, a ribbon, a wire, a wire tie, a collar, a film band, a stribbon, a paper collar, cloth, a staple, and a label.

23. A pad comprising a plurality of the floral sleeves of claim 1 held or connected together.
